(19) United States
(12) Patent Application Publication
(10) Pub. No.: US 2014/0317486 A1
(43) Pub. Date: Oct. 23, 2014

(54) REFERENCING DEVICE, METHOD AND NON-TRANSITORY COMPUTER READABLE STORAGE MEDIUM FOR STORING THEREOF FOR LINKING DOCUMENT FILE TO REFERENCED IMAGE FILE

(71) Applicant: INSTITUTE FOR INFORMATION INDUSTRY, Taipei (TW)

(72) Inventor: Kun-Hung LEE, Taipei City (TW)

(21) Appl. No.: 13/909,067

(22) Filed: Jun. 3, 2013

(30) Foreign Application Priority Data
Apr. 17, 2013 (TW) 102113621

(51) Int. Cl. G06F 17/22

(52) U.S. Cl. CPC G06F 17/2235
USPC 715/208

(57) ABSTRACT

A referencing method for linking a document file to a referenced image file is provided. The referencing method comprises the steps outlined below. The image file is provided. A plurality groups of reference information are received, in which each of the groups of reference information comprises a combination of reference symbols and/or a combination of reference characters and correspond to an image area of the image. The document file is provided. A plurality of input characters are received to edit the document file. A specific combination of characters are generated in the document file according to at least one key characters of the input characters, in which the specific combination of characters match one corresponding group of reference information. A synchronized reference link is generated between the specific combination of characters and the corresponding group of reference information.

### RELATED APPLICATIONS

This application claims priority to Taiwan Application Serial Number 102113621, filed Apr. 17, 2013, which is herein incorporated by reference.

### BACKGROUND

1. Technical Field

The present invention relates to a file linking technology. More particularly, the present invention relates to a referencing device, method and non-transitory computer readable storage medium for storing thereof for linking document file to an image file.

2. Description of Related Art

On the aspect of data processing, the computer systems have the advantages of fast data-processing ability, large data storage capacity and convenient transmission mechanism. Therefore, the computer systems can be used to edit or store lots of document files and the image files.

In some of the documents such as theoretical essays or patent specifications, the contents include both texts and images in order to clearly describe the subject matter therein. For example, the elements that are both described in texts in a document file and shown in a corresponding image file have to be labeled with numberings or symbols in both the files for the user's reference. However, an element would be presented several times in a single document file. If the user decides to modify the numbering or the symbol of an element, the user not only has to amend the image file but also has to amend all the related texts in the document files. The user would find it difficult to amend the files when a single element is presented too many times in the document file or when there are too many elements to be modified.

Accordingly, what is needed is a referencing device, method and non-transitory computer readable storage medium for storing thereof for linking document file to an image file to overcome the above issues.

### SUMMARY

A referencing method for linking a document file to an image file is provided. The referencing method comprises the steps outlined below. The image file is provided. A plurality groups of reference information are received, wherein each of the groups of reference information comprises a combination of reference symbols and/or a combination of reference characters that link together and correspond to an image area of the image file. The document file is provided. A plurality of input characters are received to edit the document file. At least one key character in the input characters is detected to generate a specific combination of characters in the document file, wherein the specific combination of characters match one corresponding group of reference information. A synchronized reference link between the specific combination of characters and the corresponding group of reference information is generated.

Another aspect of the present invention is to provide a referencing device for linking a document file to an image file. The referencing device comprises an input module, a processing module and a link-generating module. The input module receives a plurality groups of reference information and a plurality of input characters, wherein each of the groups of reference information comprises a combination of reference symbols and/or a combination of reference characters that link together and correspond to an image area of an image file. The processing module edits a document file according to the plurality of input characters. The link-generating module detects at least one key character in the input characters to generate a specific combination of characters in the document file, wherein the specific combination of characters match one corresponding group of reference information. The link-generating module further generates a synchronized reference link between the specific combination of characters and the corresponding group of reference information.

Yet another aspect of the present invention is to provide a non-transitory computer readable storage medium to store a computer program to execute a referencing method for linking a document file to an image file. The referencing method comprises the steps outlined below. The image file is provided. A plurality groups of reference information are received, wherein each of the groups of reference information comprises a combination of reference symbols and/or a combination of reference characters that link together and correspond to an image area of the image file. The document file is provided. A plurality of input characters are received to edit the document file. At least one key character in the input characters is detected to generate a specific combination of characters in the document file, wherein the specific combination of characters match one corresponding group of reference information. A synchronized reference link between the specific combination of characters and the corresponding group of reference information is generated.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a referencing device in an embodiment of the present invention;

FIG. 2A is a diagram depicting the image file displayed by the display module in an embodiment of the present invention;

FIG. 2B is a diagram depicting the document file displayed by the display module in an embodiment of the present invention;

FIG. 3 is a further detailed block diagram of the link-generating module; and

FIG. 4 is a flow chart of a referencing method in an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

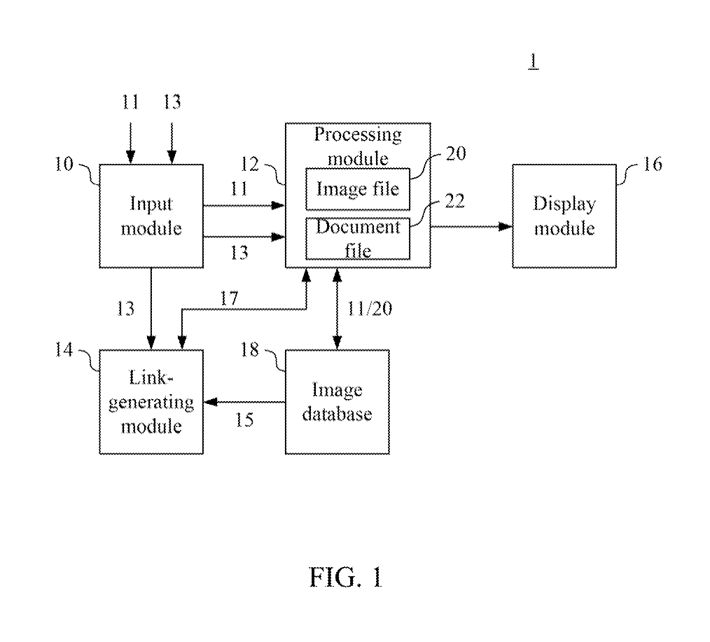

FIG. 1 is a block diagram of a referencing device 1 in an embodiment of the present invention. The referencing device 1 comprises an input module 10, a processing module 12, a link-generating module 14 and a display module 16.

In an embodiment, the input module 10 can be a keyboard, a mouse or can be integrated with the display module 16 to become a touch screen. In an embodiment, the processing module 12 can generate and provide an image file 20 and a document file 22 according to the input control of the input module 10 and further processes the image file 20 and the document file 22. In different embodiments, the image file 20 can be stored in different formats such as, but not limited to, JPG, BMP, TIFF or the formats supported by other image editing software such as CAD and Visio. The document file 22 can be stored in different formats such as, but not limited to, the file formats supported by the software Word of MicroSoft or other document processing software.

In the present embodiment, the input module 10 receives a plurality groups of reference information 11 and a plurality of input characters 13, wherein each of the groups of reference information 11 comprises a combination of reference symbols and/or a combination of reference characters that link together and correspond to an image area of an image file 20.

In the present embodiment, the processing module 12 can store the reference information 11 and the image file 20 in an image database 18. In an embodiment, the processing module 12 generates an output image file (not shown) that comprises the reference information 11 according to the reference information 11 and the image file 20. In other words, the output image file comprises not only the original content of the image file 20, but also the content of the groups of reference information 11 that is labeled on the corresponding image area of the reference information 11. The processing module 12 further edits the document file 22 according to the input characters 13.

The link-generating module 14 detects at least one key character in the input characters 13 to generate a specific combination of characters in the document file 22. The specific combination of characters match one corresponding group of reference information 15. The link-generating module 14 further generates a synchronized reference link 17 between the specific combination of characters and the corresponding group of reference information 15.

Consequently, when the specific combination of characters are presented several times in the document file 22, all these specific combination of characters presented in the document file 22 are linked with the corresponding group of reference information 15 with the generation of the synchronized reference link 17. In the present embodiment, when the content of one of the image file 20 and the document file 22 is amended, the corresponding content of the other one of the files will be amended according to the synchronized reference link 17 as well. Therefore, when the input module 10 receives an amending input to amend the corresponding group of reference information 15, the processing module 12 not only amends the corresponding group of reference information 15 in the image database 18, but also amends the specific combination of characters in the document file 22 simultaneously according to the synchronized reference link 17. Similarly, when the input module 10 receives an amending input to amend the specific combination of characters in the document file 22, the processing module 12 not only amends the specific combination of characters in the document file 22, but also amends the corresponding group of reference information 15 in the image database 18 simultaneously according to the synchronized reference link 17.

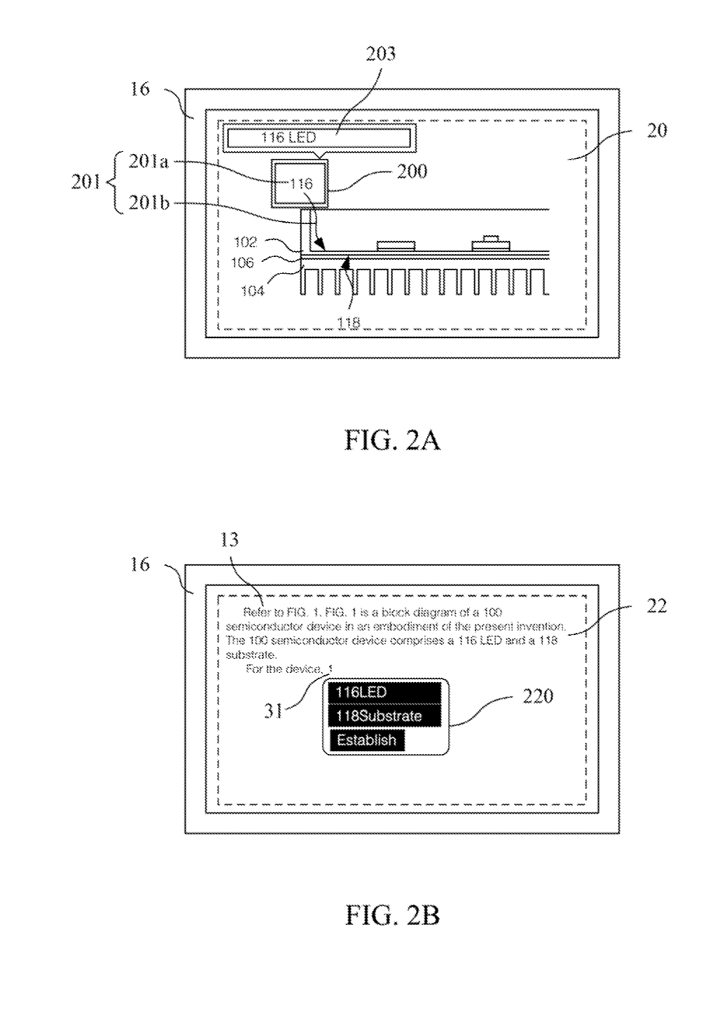

Further detail of the referencing device 1 is described below. Refer to FIG. 2A and FIG. 2B at the same time. FIG. 2A is a diagram depicting the image file 20 displayed by the display module 16 in an embodiment of the present invention. FIG. 2B is a diagram depicting the document file 22 displayed by the display module 16 in an embodiment of the present invention.

The input module 10 mentioned previously can receive the input of the reference information 11 after the reception of a pointing selection input corresponding to an image area 200 of the image file as shown in FIG. 2A, in which the pointing selection input can be performed by a clicking input of a mouse or a touch input of a touch display. In an embodiment, the reference information 11 may comprise a combination of reference symbols 201 and/or a combination of reference characters 203. In the present embodiment, the reference information 11 comprises both the combination of reference symbols 201 and the combination of reference characters 203.

The combination of reference symbols 201 comprise such as, but not limited to, numbers, symbols or characters such that the combination of reference symbols 201 can be labeled on the image area 200. In the present embodiment, the combination of reference symbols 201 comprises a numbering 201a and an arrow 201b. It is noted that the term “combination of reference symbols 201” does not limit the amount of symbols it includes. In other embodiments, the combination of reference symbols 201 may comprise an amount of symbols different from the amount of symbols in the present embodiment. For example, the combination of reference symbols 201 may comprise only one symbol or more than two symbols.

The combination of reference characters 203 mainly comprise characters as the text description of the combination of reference symbols 201. For example, the content of the combination of reference characters 203 can be “116 LED” as shown in FIG. 2A. In an embodiment, only the content of the combination of reference symbols 201 is shown on the output image file generated by the processing module 12 while the content of the combination of reference characters 203 is not shown. In other embodiments, the content of both of the combination of reference symbols 201 and the combination of reference characters 203 can be shown, or only the content of the combination of reference characters 203 is shown, depending on different applications. Nevertheless, the image file 20 and the content of both the combination of reference symbols 201 and the combination of reference characters 203 are stored in the image database 18.

The input module 10, whether it is a keyboard or a touch display capable of receiving a touch input, can receive input characters as shown in FIG. 2B to edit the document file 22. The link-generating module 14 can perform detection and comparison according to the input characters and generate the link between the image file 20 and the document file 22.

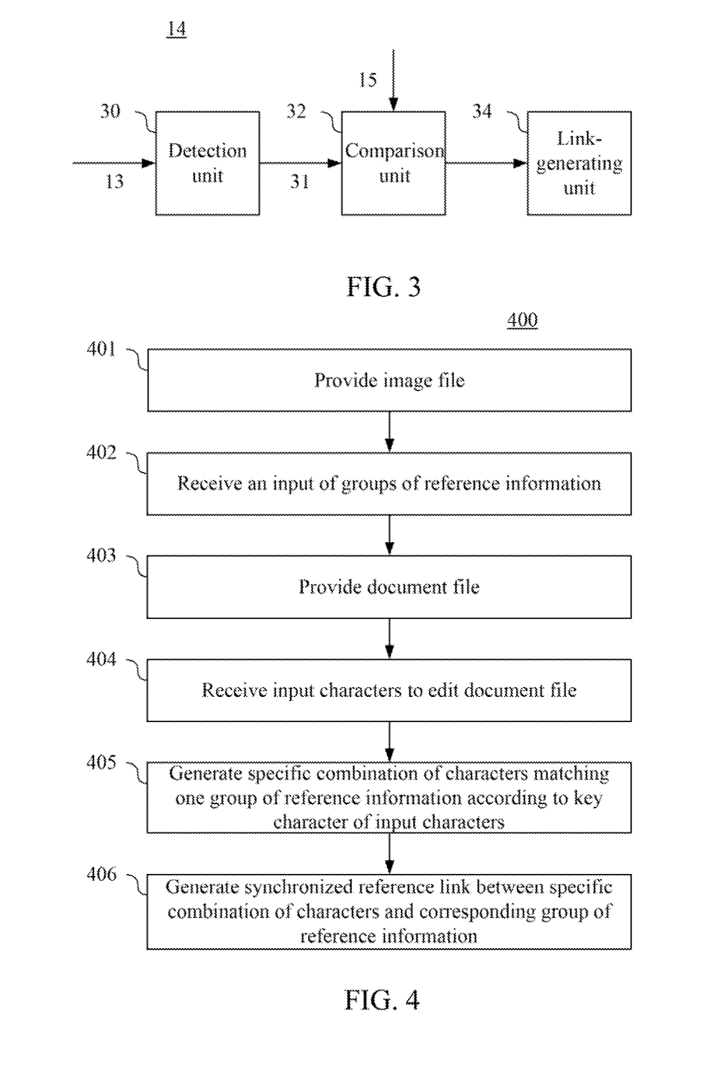

Refer to FIG. 3 at the same time FIG. 3 is a further detailed block diagram of the link-generating module 14. The link-generating module 14 comprises a detection unit 30, a comparison unit 32 and a link-generating unit 34. The detection unit 30 detects at least one key character in the input characters as shown in FIG. 2B. The key character(s) may comprise at least one common character and/or at least one activation character.

In an embodiment, the key character(s) may comprise the common character corresponding to the number, symbol or character in the reference information 11 The comparison unit 32 compares the key character(s) with the reference information 11 and displays the groups of reference information 11 related to the key character (as such as a list 220) on the display module 16 as shown in FIG. 2B.

For example, when the input characters comprise a number 1, the detection unit 30 detects the key character ‘1’The comparison unit 32 acquires the reference information related to the key character ‘1”, such as the reference information containing “116 LED” and “118 LED” on the list 220 as shown in FIG. 2B.

In another embodiment, the key character(s) may comprise the activation character only (such as the character ‘@’). The detection unit 30 can detect the activation character such that the processing module 12 retrieves all the reference information 11 stored in the image database 18 and displays the reference information 11 on the list 220 directly for the user's reference.

In yet another embodiment, the key character(s) may comprise both the activation character and the common character. For example, when the input characters comprise the characters @ and 1, the detection unit 30 can detect the activation character and activate the comparison unit 32. The comparison unit 32 can perform comparison on the basis of the common character behind the activation character to search for the related reference information in the image database 18. In an embodiment, the list 220 of all the reference information 11 can be displayed directly for the user's reference after the detection unit 30 detects the activation character. The common character can be received subsequently such that the reference information that does not match the common character can be excluded. The list 220 would thus show the reference information related to the inputted common character only after the common character is received such that the user can perform selection easily.

After the display module 16 displays the list 220, the input module 10 can receive a selection input for selecting an item, i.e. one group of reference information, on the list 220. The link-generating unit 34 selects one group of reference information 11 according to the selection input received by the input module 10 and generates a specific combination of characters. A synchronized reference link 17 is thus generated to link the specific combination of characters and the corresponding reference information For example, when the selection input selects the item “116 LED” on the list 220 in FIG. 2B, the link-generating unit 34 generates the specific combination of characters of “116 LED” in the document file 22 and generates the synchronized reference link 17 to link the specific combination of characters and the reference information of “116 LED”. Similarly, if the link-generating unit 34 generates the specific combination of characters of “116 LED” in different places in the document file 22, these combinations of characters of “116 LED” are all linked to the same reference information through the generation of the synchronized reference link 17.

Therefore, when the input module 10 receives the amending input that is intended to replace the content of the reference information of “116 LED” by “120 Power Supply”, the processing module 12 not only amends the content of the reference information but also replace the content of the specific combination of characters of “116 LED” in the document file 22 by “120 Power Supply”. The output image file can be amended accordingly as well.

Therefore, the referencing device and method of the present invention is able to synchronize the reference information in the image file and the specific combination of characters in the document file through the generation of the link between them. The amendment of the image and/or the document can be performed easily. It is noted that in an embodiment, the referencing device 1 can be implemented by a single computer host. In other embodiments, the referencing device 1 can be implemented by a server and a remote client. The server provides a webpage interface such that the input of the reference information and the characters are received by the input module of the remote client through the webpage interface. The hardware of the server can detect key character(s), generates the specific combination of characters,and generates the synchronized reference link 17 subsequently.

FIG. 4 is a flow chart of a referencing method 400 in an embodiment of the present invention. The referencing method 400 can be used in the referencing device 1 depicted in FIG. 1. More specifically, the referencing method 400 is implemented by using a computer program to control the modules in the referencing device 1. The computer program can be stored in a non-transitory computer readable medium such as a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

The referencing method 400 comprises the steps outlined below. The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 401, an image file is provided.

In step 402, the input module 10 receives a plurality groups of reference information 11, wherein each of the groups of reference information 11 comprises a combination of reference symbols and/or a combination of reference characters that link together and correspond to an image area of the image file.

In step 403, a document file is provided.

In step 404, the input module 10 receives a plurality of input characters to edit the document file.

In step 405, the processing module 12 generates a specific combination of characters in the document file according to at least one key character in the input characters, wherein the specific combination of characters match one corresponding group of reference information.

In step 406, the processing module 12 generates a synchronized reference link 17 between the specific combination of characters and the corresponding group of reference information.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A referencing method for linking a document file to an image file, wherein the referencing method comprises:
providing the image file;
receiving a plurality groups of reference information, wherein each of the groups of reference information comprises a combination of reference symbols and/or a combination of reference characters that link together and correspond to an image area of the image file;
providing the document file;
receiving a plurality of input characters to edit the document file;
detecting at least one key character in the input characters to generate a specific combination of characters in the document file, wherein the specific combination of characters match one corresponding group of reference information;
generating a synchronized reference link between the specific combination of characters and the corresponding group of reference information.

2. The referencing method of claim 1, further comprising:
receiving an amending input to amend the corresponding group of reference information or the specific combination of characters; and
amending the specific combination of characters simultaneously when the amending input is to amend the corresponding group of reference information and amending the corresponding group of reference information simultaneously when the amending input is to amend the specific combination of characters.

3. The referencing method of claim 1, wherein the step of receiving the plurality groups of reference information further comprises:
receiving a pointing selection input corresponding to the image area; and
receiving an input of the combination of reference symbols and/or the combination of reference characters at the image area to label the combination of reference symbols and/or the combination of reference characters on the image area.

4. The referencing method of claim 1, wherein the step of generating the specific combination of characters further comprises:
detecting the key character;
comparing the key character with the plurality groups of reference information;
displaying the groups of reference information related to the key character;
receiving a selection input to select one of the groups of reference information related to the key character; and
generating the specific combination of characters.

5. The referencing method of claim 4, wherein the key character comprises at least one activation character and/or at least one common character.

6. The referencing method of claim 1, further comprising:
generating an output image file having the plurality groups of reference information according to the image file and the plurality groups of reference information.

7. The referencing method of claim 1, further comprising:
storing the image file and the plurality groups of reference information in an image database.

8. A referencing device for linking a document file to an image file, wherein the referencing device comprises:
an input module to receive a plurality groups of reference information and a plurality of input characters, wherein each of the groups of reference information comprises a combination of reference symbols and/or a combination of reference characters that link together and correspond to an image area of an image file;
a processing module to edit a document file according to the plurality of input characters; and
a link-generating module to detect at least one key character in the input characters to generate a specific combination of characters in the document file, wherein the specific combination of characters match one corresponding group of reference information;
wherein the link-generating module further generates a synchronized reference link between the specific combination of characters and the corresponding group of reference information.

9. The referencing device of claim 8, wherein the input module further receives an amending input to amend the corresponding group of reference information or the specific combination of characters such that the processing module amends the specific combination of characters simultaneously when the amending input is to amend the corresponding group of reference information and amends the corresponding group of reference information simultaneously when the amending input is to amend the specific combination of characters.

10. The referencing device of claim 8, wherein the input module further receives a pointing selection input corresponding to the image area and an input of the combination of reference symbols and/or the combination of reference characters at the image area to label the combination of reference symbols and/or the combination of reference characters on the image area.

11. The referencing device of claim 8, wherein the link-generating module further comprises:
a detection unit to detect the key character;
a comparison unit to compare the key character with the plurality groups of reference information and to display the groups of reference information related to the key character through a display module; and
a link-generating unit to select one of the groups of reference information related to the key character according to a selection input received by the input module and generate the specific combination of characters.

12. The referencing device of claim 11, wherein the key character comprises at least one activation character and/or at least one common character.

13. The referencing device of claim 8, wherein the processing module further generates an output image file having the plurality groups of reference information according to the image file and the plurality groups of reference information.

14. The referencing device of claim 8, further comprises an image database, wherein the processing module stores the image file and the plurality groups of reference information in the image database.

15. The referencing device of claim 8, wherein the input module receives the plurality groups of reference information and the plurality of input characters through a webpage interface.

16. A non-transitory computer readable storage medium to store a computer program to execute a referencing method for linking a document file to an image file, wherein the referencing method comprises:
providing the image file;
receiving a plurality groups of reference information wherein each of the groups of reference information comprises a combination of reference symbols and/or a combination of reference characters that link together and correspond to an image area of the image file;
providing the document file;
receiving a plurality of input characters to edit the document file:
detecting at least one key character in the input characters to generate a specific combination of characters in the document file, wherein the specific combination of characters match one corresponding group of reference information;
generating a synchronized reference link between the specific combination of characters and the corresponding group of reference information.

17. The non-transitory computer readable storage medium of claim 16, further comprising:
receiving an amending input to amend the corresponding group of reference information or the specific combination of characters; and
amending the specific combination of characters simultaneously when the amending input is to amend the corresponding group of reference information and amending the corresponding group of reference information simultaneously when the amending input is to amend the specific combination of characters.

18. The non-transitory computer readable storage medium of claim 16, wherein the step of receiving the plurality groups of reference information further comprises:
receiving a pointing selection input corresponding to the image area; and
receiving an input of the combination of reference symbols and/or the combination of reference characters at the image area to label the combination of reference symbols and/or the combination of reference characters on the image area.

19. The non-transitory computer readable storage medium of claim 16, wherein the step of generating the specific combination of characters further comprises:
detecting the key character;
comparing the key character with the plurality groups of reference information;
displaying the groups of reference information related to the key character;
receiving a selection input to select one of the groups of reference information related to the key character; and
generating the specific combination of characters.

20. The non-transitory computer readable storage medium of claim 19, wherein the key character comprises at least one activation character and/or at least one common character.

21. The non-transitory computer readable storage medium of claim 16, further comprising:
generating an output image file having the plurality groups of reference information according to the image file and the plurality groups of reference information.

22. The non-transitory computer readable storage medium of claim 16, further comprising:
storing the image file and the plurality groups of reference information in an image database.
